(19) United States
(12) Patent Application Publication
(10) Pub. No.: US 2004/0219921 A1
(43) Pub. Date: Nov. 4, 2004

(54) Method of releasing a connection between a mobile user terminal and a network

(76) Inventors: Qiang Cao, Swindon (GB); Patrick Georges Venceslas Charriere, Tetbury (GB); Richard Llewelyn Davies, Corsham (GB); Seau Sian Lim, Swindon (GB); Philip Charles Sapiano, Corsham (GB)

Correspondence Address: Docket Administrator (Room 3J-219), Lucent Technologies Inc., 101 Crawfords Corner Road, Holmdel, NJ, 07733-3030, US

(21) Appl. No.: 10/426,597

(22) Filed: Apr. 30, 2003

(51) Int. Cl. H04B 1/00

(52) U.S. Cl. 455/444; 455/552.1

(57) ABSTRACT

A method of releasing a connection between a mobile user terminal 22 and a first network 9 if a report of presence has not been received from the mobile user terminal by the first network 9 for a predetermined period. The predetermined period being selected to be shorter than otherwise upon the mobile user terminal 22 being determined both as being capable of communicating also with another type of network 6 for mobile telecommunications, and being in an area covered by a network of said another type such that handover to said network 6 of said another type is possible.

### TECHNICAL FIELD

The present invention relates to telecommunications, and more particularly, wireless communications.

### BACKGROUND OF THE INVENTION

Telecom operators consider the ability to make Inter system handover of a mobile user terminal from a UMTS network to a GPRS network occurs under the control of the mobile user terminal. The mobile user terminal performs a cell reselection, with the assistance of the UTRAN network by providing system information to the mobile user terminal for the cell reselection.

While the mobile user terminal is in any one of CELL_FACH, CELL_PCH or URA_PCH states, e.g., when the mobile user terminal is listening to the Forward Access Channel (“FACH”) channel, or paging channel (“PCH”) of the cell or the paging channel of the UTRAN registration area (“URA”), then based on received system information, e.g., how much stronger the signal of the GPRS network is, the mobile user terminal makes a cell reselection to the GPRS network. The mobile user terminal initiates the establishment of a connection to the GPRS network in accordance with GPRS standards. When a GPRS cell is selected and a mobile user terminal to GPRS network connection establishment procedure is initiated, the mobile user terminal should release all dedicated UTRAN specific resources. The UTRAN network accordingly promptly requests to release a so-called IU connection, i.e. the connection between a radio network controller (“RNC”) and serving GPRS support node (“SGSN”), deletes the mobile user terminal information (context) stored in the UTRAN network and releases the resources dedicated to the mobile user terminal. Failure to do so may cause unnecessary excessive use of precious UTRAN resources.

One approach is for a fixed timeout period to expire before UTRAN resources are released. However, a serious waste of UTRAN resource thus occurs when mobile user terminal has selected a GPRS cell for connection and so has initiated mobile user terminal to GPRS network connection, but at the same time the UTRAN network still keeps the resources dedicated for the mobile user terminal for far longer time than necessary. The capacity of the UTRAN network is reduced by this holding of UTRAN resources unused for longer than necessary. This is especially the case where a UMTS signalling connection release request needs to be initiated by the UTRAN network (due to the fact that the core network (“CN”) is not able to promptly delete the mobile user terminal's previous UMTS signalling connection) after the mobile user terminal's GPRS signalling connection has been established.

### SUMMARY OF THE INVENTION

The present invention provides a method of releasing a connection between a mobile user terminal and a first network when a report of presence has not been received from the mobile user terminal by the first network for a predetermined period, the predetermined period being selected to be shorter than otherwise upon the mobile user terminal being determined both as being capable of communicating also with another type of network for mobile telecommunications, and being in an area covered by a network of said another type such that handover to said network of said another type is possible.

Advantageous embodiments provide its UMTS network with efficient inter-system handover capability without compromising system capacity. A timer based solution is provided for the UTRAN network to request release of the resources dedicated to a dual mode (e.g., UMTS/GPRS) mobile user terminal from the UTRAN network when the mobile user terminal has completed the handover from the UMTS network to another type of network (e.g., GPRS). The timer is modified based upon whether the mobile user terminal is capable of handing over from UMTS to GPRS (i.e inter RAT capability) and whether the mobile user terminal is in a UMTS-GPRS handover region.

In the advantageous embodiments, the monitoring timer for keeping alive the mobile user terminal's UMTS connection while briefly out of service area is thus adapted to an individual mobile user terminal's situation. In particular, the mobile user terminal's signalling monitoring timer (holding timer) used in the UTRAN network is reset so that the mobile user terminal's signalling connection won't be maintained for an excessively long time.

As compared to the known approach of using a fixed timer for all mobile user terminals regardless of mobile user terminal's inter radio access technology (inter RAT) capability and whether or not they are in an inter system handover region, considerable UTRAN resources savings result.

Advantageous embodiments are for UMTS-GPRS handover. Other embodiments relate to any inter-system handover from UMTS by means of cell reselection. The UMTS network is compliant with Third Generation Partnership Project (3GPP) standards.

Advantageously, the shorter predetermined period is selected by the mobile user terminal sending presence reports more frequently than otherwise causing the first network to reduce the predetermined periods timed from receipt of the latest received presence report during which the first network either receives a further presence report causing the timing to be restarted or sends a call connection release request if no further presence report from the mobile user terminal is received within the predetermined period.

Advantageously, the call connection release request is sent to a node of the first network connecting the first network and the network of said another type, said node controlling call connection from the first network to the mobile user terminal.

Advantageously, at least one of the networks is a wideband code division multiple access (W-CDMA) network. Advantageously, the first network is a Universal Mobile Telecommunications System (UMTS) network.

Advantageously, the node is a serving GPRS support node (SGSN).

Advantageously, the network of said other type is a General Packet Radio System (GPRS) network.

The present invention also provides a network for mobile telecommunications comprising a first network and a network for mobile telecommunications of another type, the first network comprising releasing means operative to release a connection with a mobile user terminal when a report of presence has not been received from the mobile user terminal by the first network for a predetermined period, the first network comprising selection means and determination means, the selection means being operative to select the predetermined period to be shorter than otherwise upon the mobile user terminal being determined by the determination means both as being capable of communicating also with another type of network for mobile telecommunications, and being in an area covered by a network of said another type such that handover to said network of said another type is possible.

Advantageously, in use, the shorter predetermined period is selected by the mobile user terminal sending presence reports more frequently than otherwise causing the selection means to reduce the predetermined periods timed from receipt of the latest received presence report during which the first network either receives a further presence report causing the timing to be restarted or sends a call connection release request if no further presence report from the mobile user terminal is received within the predetermined period.

Advantageously, a node of the first network connects the first network and the network of said another type and controls call connection from the first network to the mobile user terminal, and in which in use a call connection release request is sent to the node.

Advantageously, at least one of the networks is a wideband code division multiple access (“W-CDMA”) network. Advantageously, the first network is a Universal Mobile Telecommunications System (“UMTS”) network.

Advantageously, the node is a serving GPRS support node (“SGSN”).

Advantageously, the network of said other type is a General Packet Radio System (“GPRS”) network.

The present invention also provides a Universal Mobile Telecommunications System (“UMTS”) network for mobile telecommunications comprising releasing means operative to release a connection with a mobile user terminal when a report of presence has not been received from the mobile user terminal by the network for a predetermined period, the network comprising selection means and determination means, the selection means being operative to select the predetermined period to be shorter than otherwise upon the mobile user terminal being determined by the determination means both as being capable of communicating also with another type of network for mobile telecommunications, and being in an area covered by a network of said another type such that handover to a network of said another type is possible.

Advantageously, in use, the shorter predetermined period is selected by the mobile user terminal sending presence reports more frequently than otherwise causing the selection means to reduce the predetermined periods timed from receipt of the latest received presence report during which the network either receives a further presence report causing the timing to be restarted or sends a call connection release request if no further presence report from the mobile user terminal is received within the predetermined period.

### BRIEF DESCRIPTION OF THE DRAWINGS

The present invention may be better understood from reading the following description of non-limiting embodiments, with reference to the attached drawings, wherein below:

FIG. 1 is a diagram illustrating UMTS and GPRS networks;

FIG. 2 is a diagram illustrating adjustment of the timer for receiving a report of presence from a mobile user terminal; and

FIG. 3 is a diagram illustrating some functionality of the radio network controller (RNC) of the UMTS network.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

The present invention relates to a network for mobile telecommunications comprising a first network and a network for mobile telecommunications of another type, the first network comprising releasing means operative to release a connection with a mobile user terminal when a report of presence has not been received from the mobile user terminal by the first network for a predetermined period.

The present invention also relates to a Universal Mobile Telecommunications System (“UMTS”) network for mobile telecommunications comprising releasing means operative to release a connection with a mobile user terminal when a report of presence has not been received from the mobile user terminal by the network for a predetermined period.

As shown in FIG. 1, the advantageous network 7 consists of a UMTS network 9 and a GPRS network 6. Considering the UMTS network 9, in particular the main part of which is known as a UMTS terrestrial radio access network (“UTRAN”) 11, there are multiple base station controllers, known as radio network controller (RNC) in UMTS terminology, each controlling several respective base stations via respective interfaces known as Iub interfaces 12. In FIG. 1, just one radio network controller 8 and two UMTS base stations 10 (Node B in UMTS terminology) are shown for simplicity. Each UMTS base station 10 typically has three cells (e.g., radio coverage areas, also known as sectors, not shown) as the UMTS base station has three directional antennas angled at 120 degrees to each other in azimuth. Radio network controllers (“RNC”) each control several UMTS base stations and hence a number of cells.

Considering the GPRS network 6, there are multiple base station controllers (“BSC”) each controlling several respective base stations via respective interfaces known as A′ interfaces 14. In FIG. 1, just one GPRS base station controller 16 and two GPRS base stations 18 (known as base transceiver stations (“BTS”) in GPRS terminology) are shown for simplicity. GPRS base station controllers (“BSC”) each control several GPRS base stations.

The UTRAN network 11 is connected to a serving GPRS support node (“SGSN”) 20 (which is part, of the UMTS network 9) via an interface 21 known as an Iu interface. The base station controller is also connected to the serving GPRS support node (SGSN) 20.

The UMTS network 9 is required to be able to handover a mobile user terminal 20 (often denoted UE which is short for user equipment) to the other network, namely GPRS network 6 if the mobile user terminal (“UE”) is dual mode capable (e.g., usable in both UMTS and GSM/GPRS networks).

Inter system handover from the UMTS network 9 to the GPRS network 6 occurs by an operation under the control of the mobile user terminal 22, namely cell reselection, with assistance from the UTRAN network 11 in providing information required for the cell reselection.

While in CELL_FACH, CELL_PCH or URA_PCH states, i.e. when the mobile user terminal 22 is listening to the CELL_FACH channel or paging channel of the cell or the paging channel of the UTRAN 11 registration area (URA), then based on received system information, e.g., how much stronger the signal of the other system is, the mobile user terminal 22 makes a cell reselection to the GPRS network 6. The mobile user terminal 22 initiates the establishment of a connection to the GPRS network 6 in accordance with GPRS standards. When a GPRS cell is selected and a mobile user terminal 22 to GPRS connection establishment procedure is initiated, the mobile user terminal 22 should release all dedicated UTRAN specific resources. The UTRAN network 11 accordingly promptly requests to release IU connection, e.g., the connection between the radio network controller (“RNC”) 8 and the serving GPRS support node (“SGSN”) 20 over the Iu interface 21, deletes the mobile user terminal's information (known as context information) stored in the UTRAN network 11, and further releases all resources dedicated to the mobile user terminal 22.

Modifying the Timer

As shown in FIG. 2, a timer based solution is developed for the UTRAN network 11 to request release of the resources dedicated to dual mode (e.g., UMTS/GPRS) mobile user terminals 22 in handover from the UTRAN network 11 when mobile user terminal has completed the inter system handover from UMTS to the other system (e.g., GPRS). The solution is based upon modifying the timer duration based on the mobile user terminal's inter radio access technology (inter RAT) capability (i.e the fact that the mobile user terminal 22 is duel mode capable) and the fact of the mobile user terminal 22 being in a handover region between the two types (e.g., GPRS, UMTS) of networks 4,6.

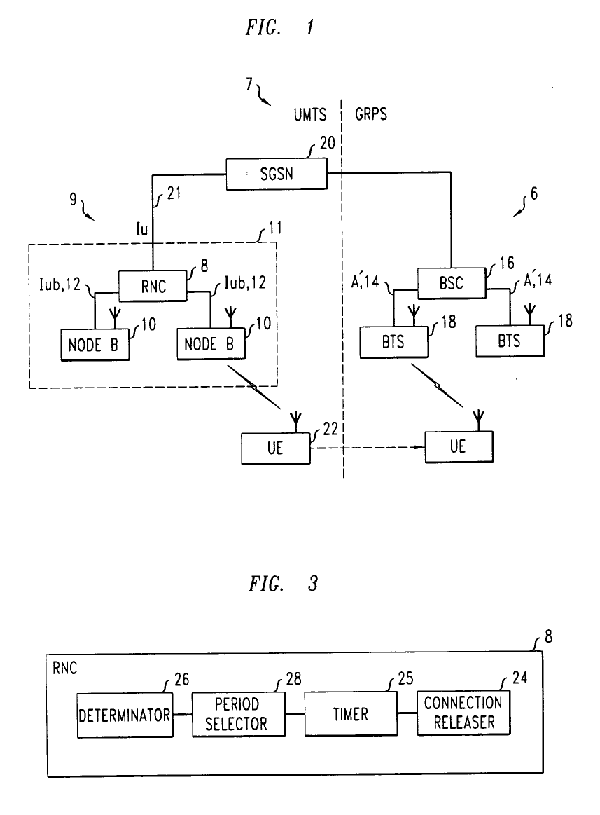

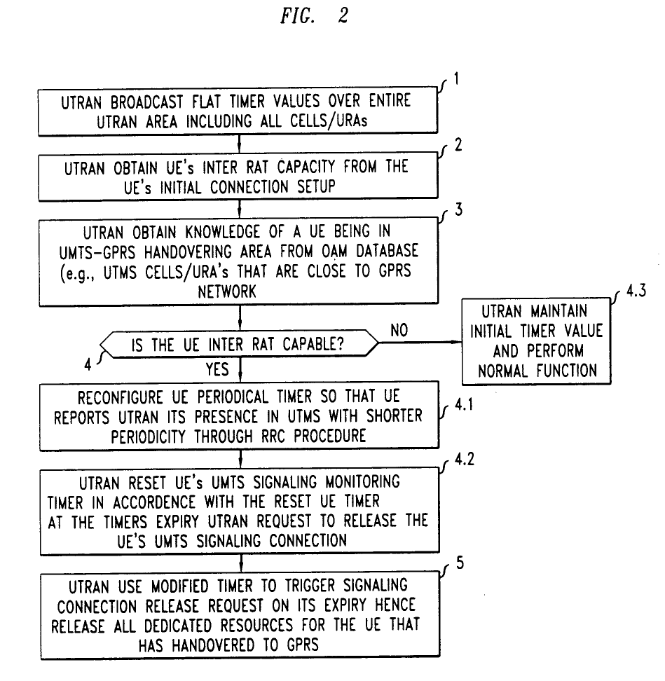

As shown in FIG. 3, the radio network controller (RNC) 8 includes a releasing function 24 operative to release a connection with the mobile user terminal 22 when a report of presence has not been received from the mobile user terminal by the network for a predetermined period as determined by a timer 25, the radio network controller (“RNC”) 8 also includes a selector function 28 and a determination function 26. The selector function 28 is operative to select the predetermined period to be shorter than otherwise upon the mobile user terminal 22 being determined by the determination function 26 both as being capable of communicating also with another type of network 6 for mobile telecommunications, and being in an area covered by a network 6 of said another type such that handover to a network 6 of said another type is possible.

The approach is suitable for mobile user terminals 22 connected to packet switched (“PS”) services in any of CELL_FACH, URA_PCH, or CELL_PCH states, as in these states, cell reselection is possible.

As shown in FIG. 2, in more detail:

Step 1: The UTRAN network 11 broadcasts over the entire UTRAN network coverage area including all cells and UTRAN registration areas to mobile user terminals default values for mobile user terminal timers as specified in 3GPP standards. This include timers denoted T305=30 minutes, T316=30 seconds, and T317=180 secs, which are used in deciding how often a mobile user terminal should inform the UTRAN network 11 that it wishes the connection to be maintained. This step 1 is denoted 1 in FIG. 2 (and so on for subsequent steps).

Step 2: The UTRAN network 11 obtains the mobile user terminal's inter radio access technology (inter RAT) capability information from the mobile user terminal's initial connection setup request (inter radio access technology (inter RAT) capability is the mobile user terminal being able access to the network via different radio access technology—e.g., UMTS, GSM/GPRS. The UTRAN network 11 received the request sometime before and stored the request for reference purposes.

Step 3: The UTRAN network 11 obtains knowledge of a mobile user terminal 22 being in a UMTS-GPRS area of possible handover from an OAM (operation, administration, and maintenance function) database, which stores locations of base stations (Node Bs). The database includes knowledge of which UMTS cells and/or UTRAN registration areas are adjacent to a GPRS network.

Step 4: The UTRAN network 11 checks by taking e.g. signal strength measurements if the mobile user terminal 22 that is in the area of possible handover is capable of performing handover from UMTS to GPRS.

If Yes:

Step 4.1: The periodical timer of the mobile user terminal 22 is reconfigured so that mobile user terminal 22 reports to the UTRAN network 11 its presence in UMTS with shorter than usual periodicity. This reconfiguration is done by appropriate radio resource control (RRC) messaging to the mobile user terminal 22.

Step 4.2: The UTRAN network 11 adjusts the timing period of the UMTS monitoring timer 25 (for that mobile user terminal 22) in accordance with the reset mobile user terminal timer in 4.1.

At the monitoring timer's expiry (i.e if and when the mobile user terminal 22 has failed to report its presence for a predetermined timed period), the UTRAN network 11 requests the serving GPRS support node (SGSN) 20 to release the mobile user terminal's UMTS signalling connection.

Step 5: The UTRAN network 11 uses the modified timer 25 to trigger a signalling connection release request on expiry of the modified timed period to the serving GPRS support node (SGSN). In consequence, the serving GPRS support node (SGSN) 20 tears down the connection between itself and the mobile user terminal 22 (via the UTRAN network 11), i.e. releases all dedicated resources for the mobile user terminal 22 that has handovered to GPRS.

Else if No:

Step 4.3: If the mobile user terminal is not capable of performing handover, the UTRAN network 11 may not send any early release request for the mobile user terminal 22 (i.e. functions 4.1 and 4.2 above are not performed). Rather the UTRAN network 11 uses the usual (initially set) timing value when determining whether the mobile user terminal has failed to report in the timed period that it is still present. If so, a signalling connection release request is sent to the serving GPRS support node (SGSN), the serving GPRS support node (SGSN) then tears down the connection between itself and the mobile user terminal 22 (via the UTRAN network 11).

In other embodiments, rather than handover being to a GPRS network 6, the handover may be to another type of mobile telecommunications network, such as another type of wideband code division multiple access (“W-CDMA”) network.

Abbreviations

BSC Base Station Controller

BTS Base Transceiver Station

Cell_FACH Cell Forward Access Channel

Cell_PCH Cell Paging Channel

CN Core Network

GPRS General Packet Radio System

Node B Base station (UMTS terminology)

RAT Radio Access Technology

RNC Radio Network Controller

SGSN Signalling GPRS support node

UE User Equipment, i.e. mobile user terminal

UMTS Universal Mobile Telecommunications System

URA UTRAN Registration Area

URA_PCH UTRAN Registration Area Paging Channel

UTRAN UMTS Terrestrial Radio Access Network

While the particular invention has been described with reference to illustrative embodiments, this description is not meant to be construed in a limiting sense. It is understood that although the present invention has been described, various modifications of the illustrative embodiments, as well as additional embodiments of the invention, may be apparent to one of ordinary skill in the art upon reference to this description without departing from the spirit of the invention, as recited in the claims appended hereto. Consequently, the method, system and portions thereof and of the described method and system may be implemented in different locations, such as network elements, the wireless unit, the base station, a base station controller, a mobile switching center and/or a radar system. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art may readily recognize that these and various other modifications, arrangements and methods can be made to the present invention without strictly following the exemplary applications illustrated and described herein and without departing from the spirit and scope of the present invention. It is therefore contemplated that the appended claims will cover any such modifications or embodiments falling within the true scope of the invention.

1. A method of releasing a connection between a mobile user terminal and a first network if a report of presence has not been received from the mobile user terminal by the first network for a predetermined period, the predetermined period being selected to be shorter than otherwise upon the mobile user terminal being determined both as being capable of communicating also with another type of network for mobile telecommunications, and being in an area covered by a network of said another type such that handover to said network of said another type is possible.

2. A method according to claim 1, wherein the shorter predetermined period is selected by the mobile user terminal sending presence reports more frequently than otherwise causing the first network to reduce the predetermined periods timed from receipt of the latest received presence report during which the first network either receives a further presense report causing the timing to be restarted or sends a call connection release request if no further presence report from the mobile user terminal is received within the predetermined period.

3. A method according to claim 2, wherein the call connection release request is sent to a node of the first network connecting the first network and the network of said another type, said node controlling call connection from the first network to the mobile user terminal.

4. A method according to claim 3, wherein the node is a serving GPRS support node (SGSN), and said network of said other type is a General Packet Radio System (GPRS) network.

5. A method according to claim 1, wherein at least one of the networks is a wideband code division multiple access (W-CDMA) network.

6. A method according to claim 4, wherein the first network is a Universal Mobile Telecommunications System (UMTS) network.

7. A method according to claim 5, wherein the node is a serving GPRS support node (SGSN).

8. A method according to claim 4, wherein the network of said other type is a General Packet Radio System (GPRS) network.

9. A system for mobile telecommunications comprising a first network and a network for mobile telecommunications of another type, the first network comprising:
releasing means operative to release a connection with a mobile user terminal if a report of presence has not been received from the mobile user terminal by the first network for a predetermined period; and
selection means and determination means, the selection means being operative to select the predetermined period to be shorter than otherwise upon the mobile user terminal being determined by the determination means both as being capable of communicating also with another type of network for mobile telecommunications, and being in an area covered by a network of said another type such that handover to said network of said another type is possible.

10. A system according to claim 9, wherein the shorter predetermined period is selected by the mobile user terminal sending presence reports more frequently than otherwise causing the selection means to reduce the predetermined periods timed from receipt of the latest received presence report during which the first network receives a further presence report causing the timing to be restarted or sends a call connection release request if no further presence report from the mobile user terminal is received within the predetermined period.

11. A system according to claim 9, wherein a node of the first network connects the first network and the network of said another type and controls call connection from the first network to the mobile user terminal, and wherein a call connection release request is sent to said node.

12. A system according to claim 11, wherein the node is serving GPRS support node (SGSN) and the network of said other type is a General Packet Radio System (GPRS) network.

13. A system according to claim 9, wherein at least one of the networks is a wideband code division multiple access (W-CDMA) network.

14. A system according to claim 13, wherein the first network is a Universal Mobile Telecommunications System (UMTS) network.

15. A Universal Mobile Telecommunications System (UMTS) network for mobile telecommunications comprising releasing means operative to release a connection with a mobile user terminal when a report of presence has not been received from the mobile user terminal by the network for a predetermined period, the network comprising selection means and determination means, the selection means being operative to select the predetermined period to be shorter than otherwise upon the mobile user terminal being determined by the determination means both as being capable of communicating also with another type of network for mobile telecommunications, and being in an area covered by a network of said another type such that handover to a network of said another type is possible.

16. A UMTS network according to claim 15, wherein the shorter predetermined period is selected by the mobile user terminal sending presence reports more frequently than otherwise causing the selection means to reduce the predetermined periods timed from receipt of the latest received presence report during which the first network receives a further presence report causing the timing to be restarted or sends a call connection release request if no further presence report from the mobile user terminal is received within the predetermined period.
